(19) United States
(12) Patent Application Publication
(10) Pub. No.: US 2011/0265184 A1
(43) Pub. Date: Oct. 27, 2011

(54) SECURITY MONITORING METHOD, SECURITY MONITORING SYSTEM AND SECURITY MONITORING PROGRAM

(76) Inventor: Hiroshi Sakaki, Tokyo (JP)

(21) Appl. No.: 13/133,722

(22) PCT Filed: Dec. 24, 2009
(86) PCT No.: PCT/JP2009/071426

§ 371 Date: Jun. 9, 2011

(30) Foreign Application Priority Data
Jan. 7, 2009 (JP) 2009-001490

(51) Int. Cl. G06F 21/00

(52) U.S. Cl. 726/25

(57) ABSTRACT

A security monitoring method is disclosed for acquiring plural items of observation information representative of a security state of a device, and for judging whether or not the device is secure through a policy based on the plural items of observation information. Transmission information that is defined as information representative of relevant observation information is retained. It is determined whether or not security judgment is possible through said transmission information alone in place of the plural items observation information. When it is possible, the transmission information in place of all or part of said plurality items of observation information is transmitted.

### TECHNICAL FIELD

The present invention relates to a security monitoring method, security monitoring system and security monitoring program for acquiring plural items of observation information representative of a security state of a device, and for judging whether or not the device is secure through a policy based on the plural items of observation information.

### BACKGROUND ART

Patent literature 1 discloses, by way of example, a conventional security monitoring system. In the security monitoring system disclosed in Patent literature 1, a state verification device that checks whether or not a computer is secure, is arranged in a computer to be checked and a state certification that certifies that the computer is secure is created and transmitted by the computer. This configuration makes it possible to check whether each device is secure, with communications traffic less than that when the state of each device is transmitted.

Patent literature 2 discloses, by way of example, an agent technology that reduces communications traffic. In the agent technology disclosed in Patent literature 2, when data among agents is synchronized or when information retained by other agent(s) is acquired, an agent to be questioned in order to obtain correct information is determined by learning, thus reducing the communications traffic required for searching for the agent.

### PRIOR ART DOCUMENTS

### Patent Literature

Patent Literature 1: JP2005-128622A
Patent Literature 2: JP2000-112904A

### SUMMARY OF THE INVENTION

### Problems to be Solved by the Invention

The above-mentioned techniques suffer from the following problems:

Firstly, a large amount of communications traffic is required for transmitting detailed information of each device required for monitoring security.

Secondly, the conventional method that has reduced communications traffic is unable to combine states of plural pieces of equipment into a policy.

It is an object of the present invention to provide a security monitoring method, security monitoring system and security monitoring program which are capable of monitoring the security of plural devices with less communications traffic.

### Means to Solve the Problems

A security monitoring method according to the present invention comprises: retaining transmission information that is defined as information representative of relevant observation information; determining whether or not a security judgment through a policy is possible through said transmission information alone in place of the plural items observation information, and when it is possible, transmitting the transmission information in place of all or part of the plurality items of observation information.

A security monitoring system according to the present invention comprises:

policy storing means that stores policies which are criteria for judging whether or not a monitored system is secure;

observation knowledge storage means that stores observation knowledge that describes plural items of observation information which are information of devices, and the manner for analyzing the plural items of observation information, in order to judge whether or not the monitored system is secure;

system analysis means that analyses the state of the monitored system based on the observation knowledge stored in said observation knowledge storage means;

transmission knowledge storing means that stores combinations of transmission information and the observation information that are knowledge to be transmitted instead of transmitting all the items of the observation information analyzed by said system analysis means;

transmission knowledge determination means that receives said observation information analyzed by said system analysis means and a policy from said policy storage means, and determines whether or not transmission of the transmission information in place of respective items of observation information will have an influence on the determination of a policy, based on the information stored in said transmission knowledge storing means; and

information transmission means that transmits the observation information, and the transmission information for which a determined has been made not to have an influence on the determination of a policy by said transmission knowledge determination means.

When the system analysis means has determined that the transmission information be transmitted by the transmission knowledge means in place of the plural items of observation information of each device observed, the security monitoring system operates to transmit the transmission information in place of the plural items of observation information.

### Effects of the Invention

The present invention provides the following advantages:

Firstly, the amount of information to be transmitted can be reduced. This is because in place of transmitting all the information that has been observed, information that can be judged not to affect the determination of policy is transmitted in a lump.

Secondly, monitoring the security of a system that is configured by plural devices is possible. This is because information that is required for the determination of policy does not need to be transmitted in a lump.

### BRIEF EXPLANATION OF THE DRAWINGS

FIG. 1 is a block diagram illustrating a security monitoring system of a first exemplary embodiment according to the present invention.

FIG. 2 is a flowchart illustrating operation of the security monitoring system of the first exemplary embodiment shown in FIG. 1.

FIG. 3 is a block diagram illustrating a security monitoring system of a second exemplary embodiment according to the present invention.

FIG. 4 is a flowchart illustrating operation of the security monitoring system of the second exemplary embodiment shown in FIG. 3.

FIG. 5 is a block diagram illustrating a security monitoring system of a third exemplary embodiment according to the present invention.

FIG. 6 is a flowchart illustrating operation of the security monitoring system of the third exemplary embodiment shown in FIG. 5.

FIG. 7 is a block diagram illustrating an application of the security monitoring system of the third exemplary embodiment.

FIG. 8 is a table illustrating a specific example of observation knowledge.

FIG. 9 is a table illustrating a specific example of observation information.

FIG. 10 is a table illustrating a specific example of transmission knowledge.

### EXPLANATION OF SYMBOLS

1 PC
2 network device
3 system monitoring PC
11 policy input section
12 policy storing section
13 observation knowledge storing section
14 system analysis section
15 transmission knowledge storing section
16 transmission knowledge determination section
17 information transmission section
18 transmission knowledge conversion section
19 policy determination section
20 transmission knowledge generation section
101˜104, 201˜206, 301˜304 step

### BEST MODE FOR CARRYING OUT THE INVENTION

Best modes for carrying out the present invention will now be described in detail with reference to the drawings.

### First Exemplary Embodiment

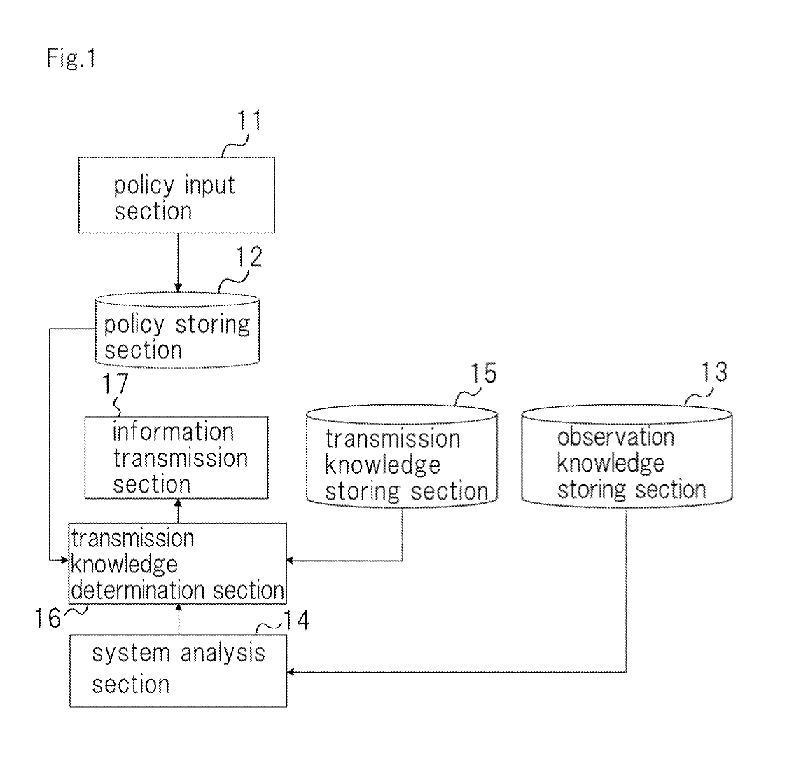

Referring to FIG. 1, a security monitoring system according to the present embodiment comprises policy input section 11, policy storing section 12, observation knowledge storing section 13, system analysis section 14, transmission knowledge storing section 15, transmission knowledge determination section 16 and information transmission section 17.

Policy input section is a means for a security observer to input a policy that defines a secure state by combining observation information of each device.

Policy storing section 12 is a means for storing a policy that is defined using one or plural items of observation information and is input from policy input section 11, the policy being criteria for determining whether or not a system whose security is to be monitored is secure. A policy is expressed by an equation that takes a truth-value. For example, when the observation information is a1, a2, a3 and a4, then policy P can be expressed as P=((a1=b1) [symbol] !a2)ν((a3=b1) [symbol] (a4!=b1), where b1, b2 and b3 are values of the observation information. When P is true, the system whose security is to be monitored is secure. In this case, when both (a1=b1) and !a2 are true or when both (a3=b1) and (a4!=b1) are true, then P is true. This leads to the fact that the system whose security is to be monitored can be determined to be secure. P may be comprised of plural rules, and may have a priority. The former is a case where P=(p1, p2, p3, . . . , where p1, p2, p3, . . . are each expressed by an equation that takes a truth-value. In general, when a policy is determined, any of p1, p2, . . . , pn may be established. However, the latter is a case where the truth-value of each rule is determined in order from p1, and when a rule that is true is found, the truth-values of the subsequent rules are not determined, and the policy is determined to be true. Conversely, when even one of the rules is not true, the policy may be determined to be not true.

Observation knowledge storing section 13 is a means for storing observation knowledge that describes system information required for determining the risk of a system whose security is to be monitored, that is, observation information which is information of each device and which is used for determining whether the system is secure, and the manner for analyzing the observation information.

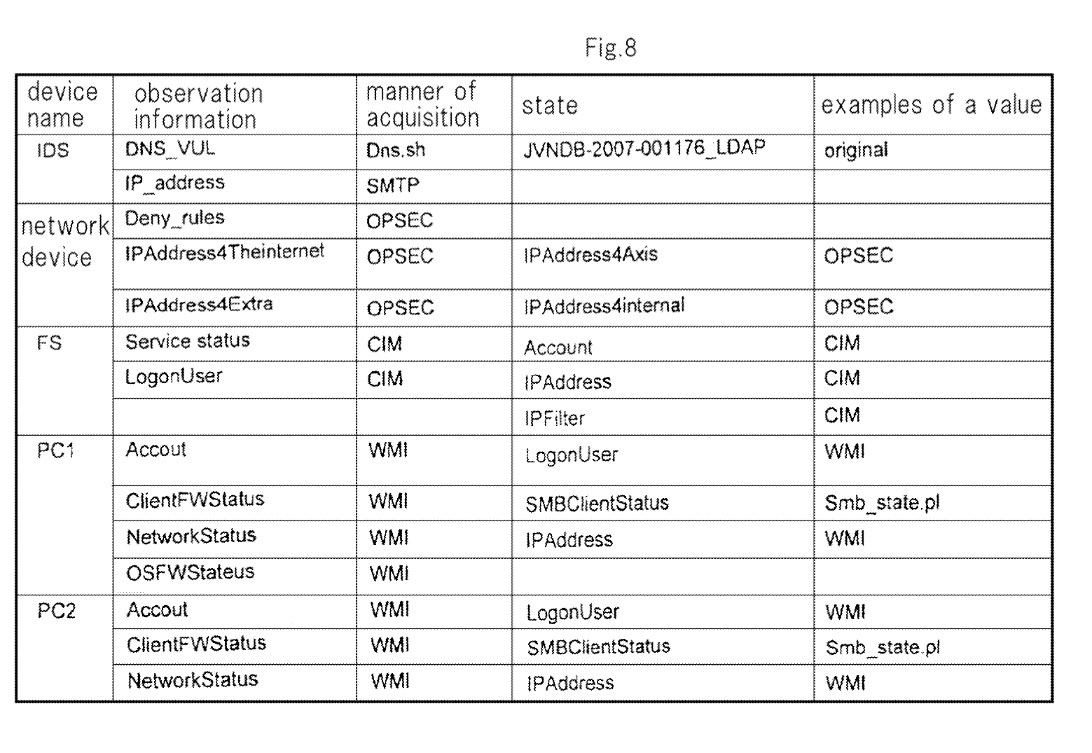

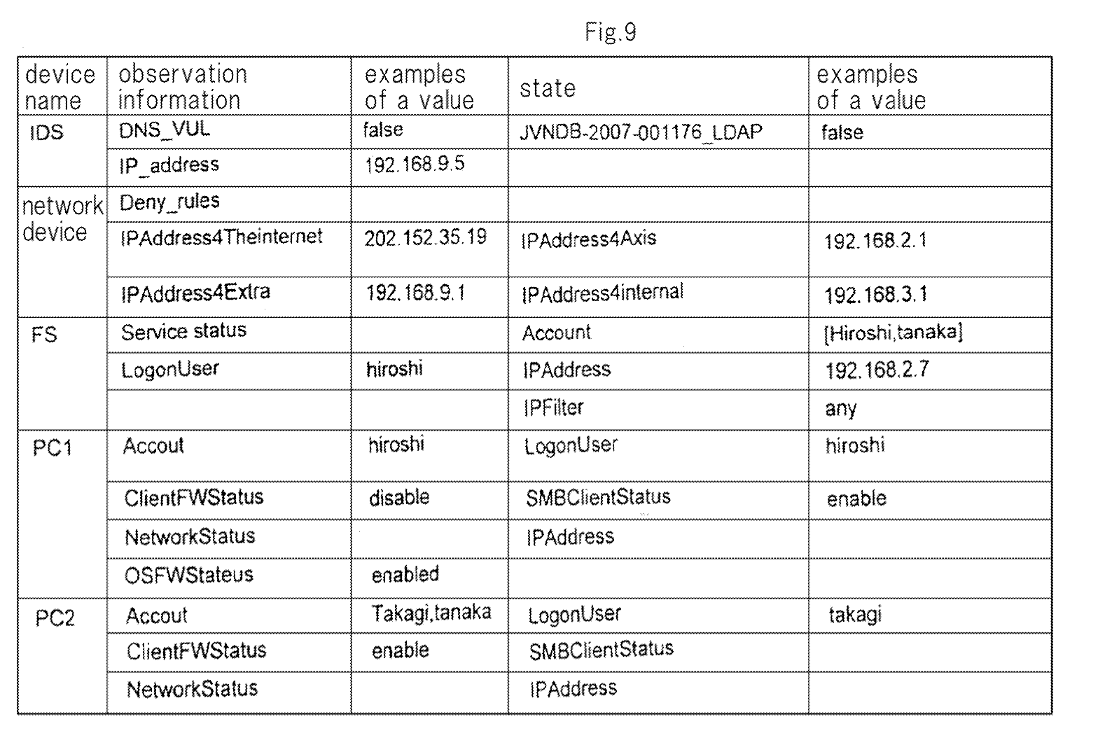

System analysis section 14 is a means for receiving from observation knowledge storing section 13 the observation knowledge that includes one or plural items of observation information which are the system information to be analyzed and the manner for analyzing the observation information, for analyzing the configuration and state of the system and for retrieving the value of each item of the observation information from the system. The retrieval of the value of each item of the observation information may be performed by embedding a program in each device or by using a means which has been previously prepared for management, such as a CIM (Computer Integrated Manufacturing) database, SMTP (Simple Mail Transfer Protocol) and etc. A specific example of observation knowledge is shown in FIG. 8, and a specific example of observation information is shown in FIG. 9.

Transmission knowledge storing section 15 stores combinations of the transmission information and the observation information that are knowledge to be transmitted, instead of transmitting all items of the observation information that are analyzed by system analysis section 14. Specifically, transmission knowledge storing section 15 stores plural items of observation information that are present in the same device; plural items of information whose values are simultaneously changed, such as plural items of information present in the same device, plural items of observation information for the same application, plural items of observation information for the same service etc.: and plural items of observation information that are considered to be changed simultaneously when a device or a service is set up etc. That is, transmission knowledge storing section 15 stores transmission knowledge that are correspondences between transmission information that defines observation states grouped based on the fact that plural items of observation information are changed simultaneously, based on the timing at which observation information is changed, and based on the fact that plural items of observation information are present in the same device, as a lump state, and the lumped observation information.

Transmission knowledge determination section 16 receives one or plural items of the observation information that are analyzed by system analysis section 14 and a policy from policy storing section 12, and determines whether or not transmission of the transmission information instead of transmitting each item of observation information will have an influence on the policy determination. Transmission knowledge storage section 15 stores combinations of plural items of observation information that will not have an influence on the policy determination as information. When there is a combination of one or plural items of information among the combinations stored in transmission knowledge storage section 15 that coincides with the combination of one or the plural items of observation information received from system analysis section 14, transmission knowledge determination section 16 determines that the combination is a combination that will not have an influence on the policy determination Specifically, transmission knowledge determination section 16 receives transmission knowledge from transmission knowledge storage section 15, a policy from policy storage section 12, and determines that when it retrieves, from among the grouped plural items of observation information included in the transmission information, observation information that is not used separately in the policy, that is, observation information that is utilized always in combination with the policy, not the observation information, but the transmission information is transmitted, otherwise the observation information is transmitted. Therefore, plural items of observation information can be organized into one or plural items of transmission information which are fewer than the number of observation information that will not have an influence on the result of policy determination.

Information transmission section 17 transmits to transmission knowledge conversion section (not shown) observation information for which a determination has been made that it should be transmitted, that is, a determination has been made to transmit information that will not have an influence on the policy determination by transmission knowledge determination section 16, and transmission information. Here, the transmission quantity of the transmission information is smaller than the transmission quantity of the plural piece of observation information. Candidates for the transmission information are determined, the number of the observation information is compared with the number of the candidates for the transmission information, and when the latter is fewer than the former, the transmission information may be transmitted.

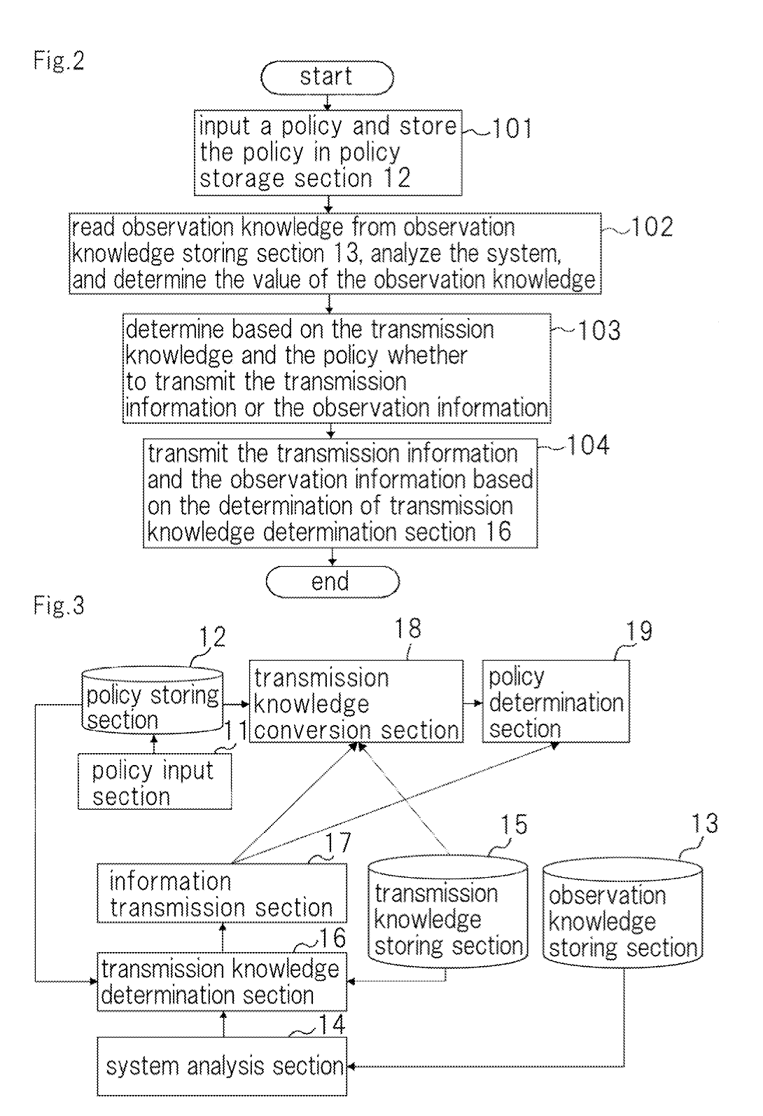

The overall operation of the present exemplary embodiment will now be described in detail with reference to the flowcharts shown in FIGS. 1 and 2.

First, a policy is input using policy input section 11, and is stored in policy storage section 12 (step 101). Next, system analysis section 14 reads the observation knowledge from observation knowledge storage section 13, analyses the system, and determines the value of the observation information by inquiring the same from the observation object (step 102). Next, transmission knowledge determination section 16 determines whether the transmission information or the observation information is to be transmitted based on the transmission knowledge and the policy (step 103). Finally, in accordance with the determination of transmission knowledge determination section 16, information transmission section 17 transmits the observation information and transmission information (step 104).

Effects of the present exemplary embodiment will now be described.

In the present exemplary embodiment, whether or not the transmission information into which plural items of observation information are grouped is to be transmitted is determined by transmission knowledge determination section 16 within a range that will not have an influence on policy determination. When it is determined that the transmission information is to be transmitted, the transmission information is transmitted in place of some items of observation information. Thus, monitoring of security is possible by transmitting a smaller quantity of information.

### Second Exemplary Embodiment

Referring to FIG. 3, a security monitoring system according to the present embodiment comprises policy input section 11, policy storing section 12, observation knowledge storing section 13, system analysis section 14, transmission knowledge storing section 15, transmission knowledge determination section 16, information transmission section 17, transmission knowledge conversion section 18 and policy determination section 19.

The security monitoring system according to the present embodiment has a configuration, in addition to the configuration of the first exemplary embodiment, that comprises transmission knowledge conversion section 18 and policy determination section 19.

In order to determine whether or not the observation information and the transmission information that are transmitted by information transmission section 17 satisfy the policy, using the observation information and the transmission information, transmission knowledge conversion section 18 reads, from among the policies defined by the observation information alone, the observation information from transmission knowledge storage section 15 that corresponds to the transmission information transmitted from information transmission section 17, replaces the observation information with the transmission information, and stores the transmission information in transmission knowledge storage section 15. Alternatively, transmission knowledge conversion section 18 determines whether or not the observation information and the transmission information that are transmitted by information transmission section 17 satisfy a secure policy that defines a secure combination of the observation information, using the observation information and the transmission information.

Policy determination section 19 determines whether or not the policy that has been replaced by the transmission information that is transmitted by information transmission section 17 is satisfied, by applying the transmission information and the observation information to the policy (i.e., substituting the value of each item of information into the policy).

The overall operation of the present exemplary embodiment will now be described in detail with reference to the flowcharts shown in FIGS. 3 and 4.

First, a policy is input using policy input section 11, and is stored in policy storage section 12 (step 201). Next, system analysis section 14 reads the observation knowledge from observation knowledge storage section 13, analyses the system, and determines the value of the observation information (step 202). Next, transmission knowledge determination section 16 determines whether the transmission information or the observation information is to be transmitted based on the transmission knowledge and the policy (step 203). Next, in accordance with the determination of transmission knowledge determination section 16, information transmission section 17 transmits the observation information and transmission information (step 204). Transmission knowledge conversion section 18 converts the policy comprised of the observation information alone into the observation information or the transmission information transmitted by information transmission section 17 so that determination of policy is possible (step 205). Finally, policy determination section 19 determines whether or not the monitored system satisfies the policy (step 206).

The effects of the present exemplary embodiment will now be described.

In the present exemplary embodiment, whether or not the transmission information into which plural pieces of observation information are grouped is to be transmitted is determined by transmission knowledge determination section 16 within a range that will not have an influence on policy determination. When it is determined that the transmission information is to be transmitted, the transmission information is transmitted in place of some items of observation information, and it is determined whether or not the policy has been satisfied from the transmission information and the observation information Thus, monitoring of security is possible by transmitting a smaller quantity of information.

### Third Exemplary Embodiment

Referring to FIG. 3, a security monitoring system according to the present embodiment comprises transmission knowledge generation section 20 in addition to the configuration of second exemplary embodiment.

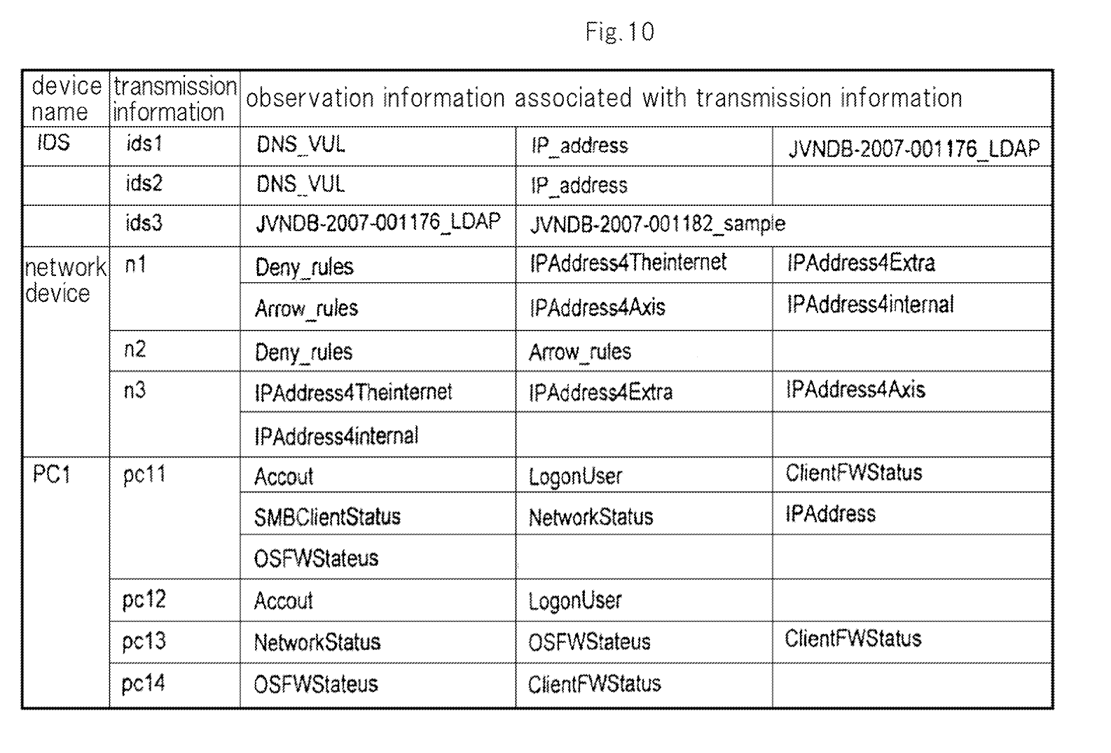

Transmission knowledge generation section 20 retrieves a policy from policy storage section 12, and defines a new state (transmission information) by combining plural items of observation information from among observation information stored in observation knowledge storage section 13 that constitutes the policy. Further, transmission knowledge generation section 20 extracts a combination of plural items of observation information that will not have an influence on the determination of policy or will not increase the number of states even when the transmission information is utilized in place of the plural items of observation information, and stores its correspondence in transmission knowledge storage section 15. A combination of plural items of the observation information that will not have an influence on the determination of a policy or that will not increase the number of states refers to a combination of the same observation information in the same device or a combination of observation information wherein part of the plural items of observation information that constitutes the combination does not appear in other policies or is not utilized in combination with other observation information. A specific example of the transmission knowledge is shown in FIG. 10.

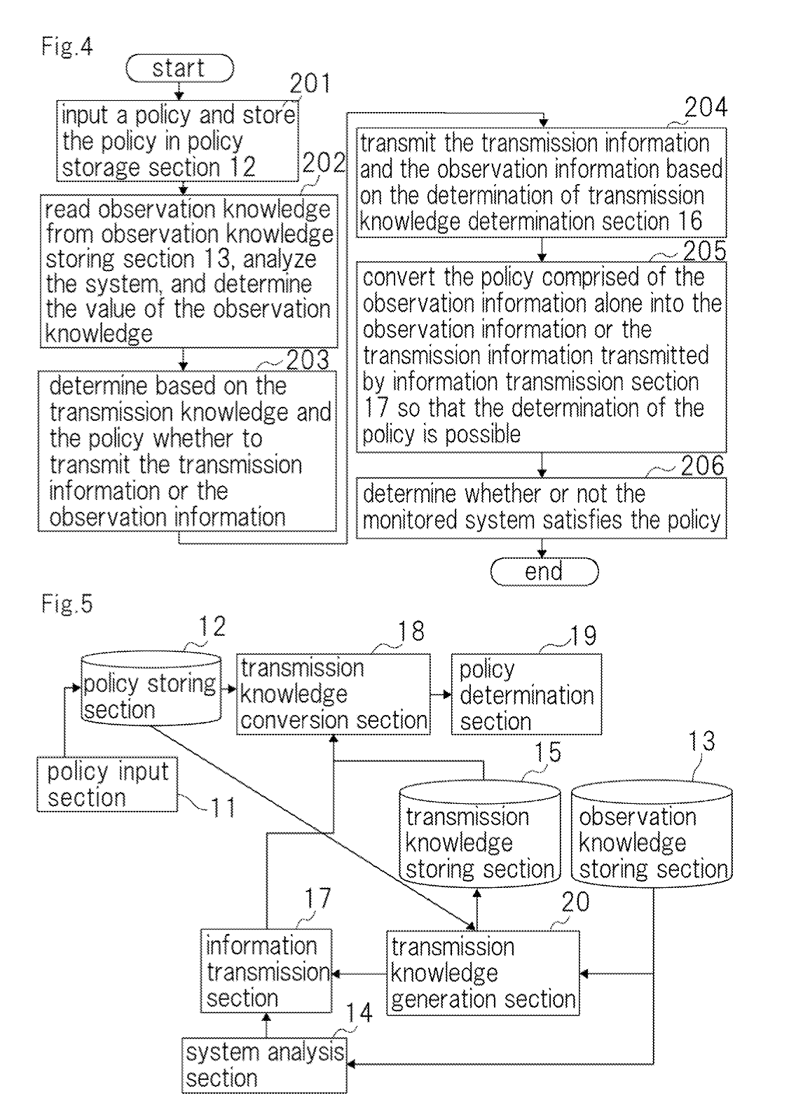

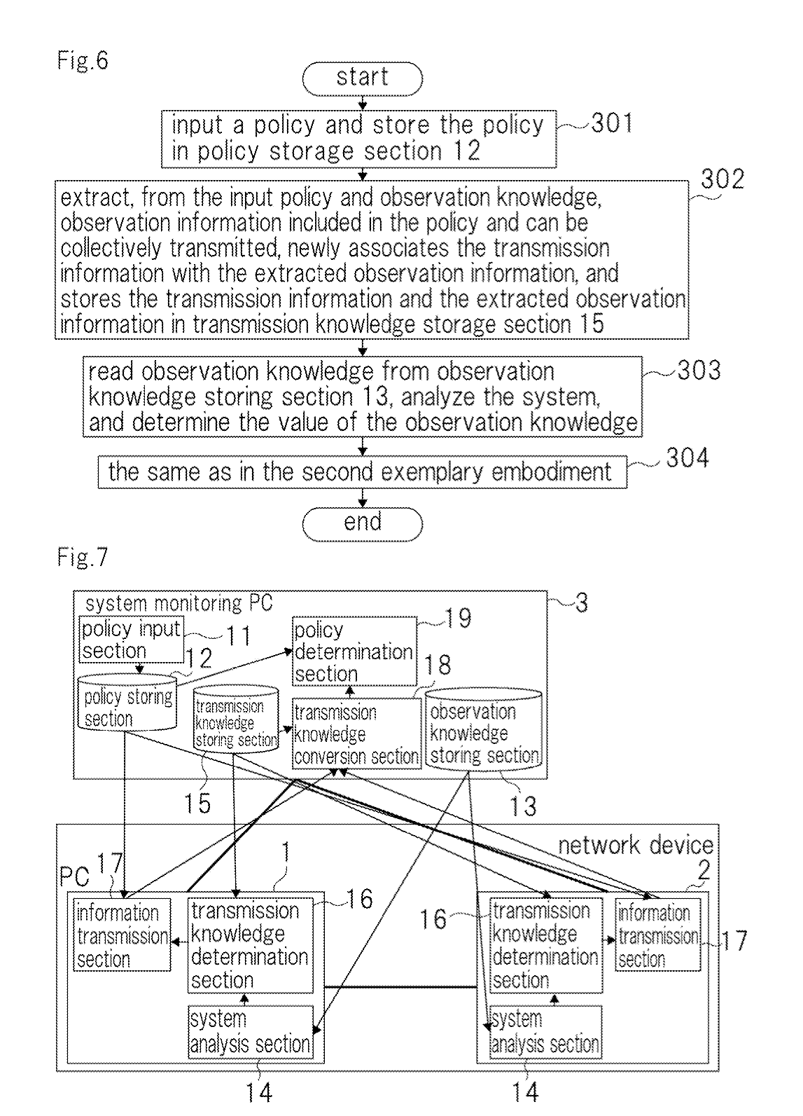

The overall operation of the present exemplary embodiment will now be described in detail with reference to the flowcharts shown in FIGS. 5 and 6.

First, a policy is input using policy input section 11, and is stored in policy storage section 12 (step 301). Next, transmission knowledge generation section 20 extracts, from the input policy and the observation knowledge, observation information that is included in the policy and can be collectively transmitted, newly associates the transmission information with the extracted observation information, and stores the transmission information and the extracted observation information in transmission knowledge storage section 15 (step 302). Next, system analysis section 14 reads the observation knowledge from observation knowledge storage section 13, analyses the system, and determines the value of the observation information (step 303).

Effects of the present exemplary embodiment will now be described.

The present exemplary embodiment is configured to generate transmission information that can be associated with the plural items of observation information using the policy and the observation information. Therefore, an analysis of risk in which there is a reduced amount of communication traffic is possible without having to previously generate transmission knowledge.

Referring to FIG. 7, there is shown monitored PC 1 and network device 2 as a monitored system, and system monitor PC 3 for monitoring them. PC 1 and network device 2 each include system analysis section 14, transmission knowledge determination section 16 and information transmission section 17. System monitoring PC 3 includes policy input section 11, policy storing section 12, policy determination section 19, transmission knowledge storage section 15, transmission knowledge conversion section 18 and observation section storage section 13.

First, a user defines as a policy a secure state in which plural items of observation information are combined, using policy creation means (not shown).

Assume that the observation information is as follows:

Deny#rule: observation information representative of a filtering rule for network device 2;
ClientFWStatus: observation information representative of a filtering rule for a firewall software introduced in PC1;
OSFWStatus: observation information representative of a filtering rule for an OS introduced in PC1;
NetworkStatus: observation information representative of a state in which PC1 is connected to a network;
IPAddress: observation information representative of an IP address of PC1.

A policy using these monitoring states includes a policy, for example: in which filtering is applied to a connection from the outside (p1), and when it is impossible, in which a network is disconnected (p1). (in this case, p1 always has precedence over p2)

p1=(IPAddress in Deny#rule)ν(ClientFWStatus=enable)ν(OSFWStatus=enable)
p2=(NetworkStatus=disable)

Next, transmission knowledge determination section 16 determines the transmission information from the transmission knowledge and the policy. Referring to the transmission knowledge shown in FIG. 10, ClientFWStatus, OSFWStatus, NetworkStatus and IPAddress are associated with each other as transmission information pc11, ClientFWStatus, OSFWStatus, NetworkStatus are associated with each other as transmission information pc13, and ClientFWStatus and OSFWStatus. are associated with each other as transmission information pc14. Here, NetworkStatus and other observation information are separated into p1 and p2, respectively. Therefore, when pc11 or pc13, which include NetworkStatus and other observation information, is transmitted, determination of the policy p1 and p2 is impossible. That is, policy pc11 and pc13 cannot be transmitted. On the other hand, ClientFWStatus and OSFWtatus in pc14 are included in the same policy. When a policy that includes ClientFWStatus and OSFWtatus is extracted based on the two items of observation information, then the policy is as follows:

(ClientFWStatus=enable) [symbol] (OSFWStatus=enable)
Since in this policy, ClientFWStatus and OSFWtatus do not appear in portions other than this portion, transmission of the result of determination of this portion does not have an influence on policy determination.

The security monitoring system described above may be carried out by recording a program for performing its functions in a computer-readable recording medium, reading the program recorded in the recording medium into a computer. The computer-readable recording medium may refer to recording medium such as flexible disk, a magneto-optical disk, CD-ROM and the like, and storage devices such as a hard disk drive incorporated in a computer system and the like. The computer-readable recording medium may also refer to a medium for dynamically holding a program for a short period of time (transmission medium or transmission wave) for use in applications for transmitting a program through the Internet, or a medium for holding the program for a certain period of time, e.g., a volatile memory in a computer system which operates as a server in such an application.

Although the preferred embodiments of present invention have been described using specific terminology, such descriptions are made only for purposes of illustration, and it should be understood that various changes and modifications can be made without departing from the appended claims.

This application claims the benefit of priority based on Japanese Patent Application No. 2009-001490 filed on Jan. 7, 2009, the entire disclosure of which is hereby incorporated by reference.

1. A security monitoring method of acquiring plural items of observation information representing a security state of a device, and judging whether or not the device is secure through a policy based on said plural items of observation information, said method comprising:
retaining transmission information that is defined as information representative of relevant observation information;
determining whether or not a security judgment through a policy is possible through said transmission information alone in place of said plural items observation information, and
when it is possible, transmitting said transmission information in place of all or part of said plurality items of observation information.

2. The security monitoring method according to claim 1, wherein the transmission quantity of said transmission information is less than the transmission quantity of said plural items of observation information.

3. The security monitoring method according to claim 1, wherein said method further comprises combining said plural items of observation information into plural items of transmission information that are fewer than said plural items of observation information and that do not have an influence on the result of a determination of a policy.

4. The security monitoring method according to claim 3, wherein it further comprises determining candidates for said transmission information, comparing the number of the candidates with the number of said plural items of observation information, and when the former is smaller than the latter, transmitting said candidates for said transmission information.

5. The security monitoring method according to claims claim 1, wherein it further comprises previously determining said transmission information, and notifying a monitor means of said transmission information.

6. The security monitoring method according to claim 1, wherein it is determined whether or not said observation information and said transmission information satisfy the policy using these items of information.

7. The security monitoring method according to claim 1, wherein it is determined whether or not said observation information and said transmission information satisfy the security policy that defines a secure combination of plural items of observation information using said observation information and said transmission information.

8. The security monitoring method according to claim 6, wherein by using a combination of the transmission information and the plural items of the observation information that have been combined into said transmission information, the transmitted transmission information is replaced by said plural items of the observation information, and it is determined whether or not said plural items of the observation information satisfy the policy.

9. The security monitoring method according to claim 6, wherein by using a combination of the transmission information and the plural items of the observation information that have been combined into said transmission information, the plural items of the observation information in the policy are replaced by the transmission information in agreement with the observation information and the transmission information that are transmitted, and it is determined whether or not the replaced transmission information satisfies the policy.

10. A security monitoring system comprising:
policy storing means that stores policies which are criteria for judging whether or not a monitored system is secure;
observation knowledge storage means that stores observation knowledge that describes plural items of observation information which are information of devices, and the manner for analyzing the plural items of observation information, in order to judge whether or not the monitored system is secure;
system analysis means that analyses the state of the monitored system based on said observation knowledge stored in said observation knowledge storage means;
transmission knowledge storing means that stores combinations of transmission information and the observation information that are knowledge to be transmitted instead of transmitting all the items of the observation information analyzed by said system analysis means, wherein the transmission information is defined as information representative of relevant observation information;
transmission knowledge determination means that receives said observation information analyzed by said system analysis means and a policy from said policy storage means, and determines whether or not transmission of the transmission information in place of respective items of observation information will have an influence on the determination of a policy, based on the information stored in said transmission knowledge storing means; and
information transmission means that transmits the observation information, and the transmission information for which a determined has been made not to have an influence on the determination of a policy by said transmission knowledge determination means.

11. The security monitoring system according to claim 10, further comprising:
transmission knowledge conversion means that converts the policy comprised of the plural items of the observation information alone into the policy comprised of the transmission information and the plural items of observation information that have been transmitted by said information transmission means so that determination of a policy may be possible based on the plural items of observation information and the transmission information that have been transmitted by said information transmission means; and
policy determination means that determines whether or not the transmission information and the plural items of observation information satisfy the policy.

12. The security monitoring system according to claim 11, further comprising transmission knowledge generation means that retrieves a policy from said policy storage means, defines a new state by combining plural items of observation information from among the plural items of observation information that constitute said policy, extracts a combination of the plural items of observation information that does not have an influence on the determination of a policy or does not increase the number of states even when the transmission information is utilized in place of the plural items of observation information, and stores the correspondence between the transmission information and the plural items of observation information in said transmission knowledge storage means as transmission knowledge.

13. A computer program product, embodied on a tangible computer readable medium, which when executed causes a computer to perform:
system analysis procedure that analyses the state of a monitored system based on observation knowledge stored in an observation knowledge storage means in order to judge whether or not the monitored system is secure, said observation knowledge including plural items of observation information that are information of devices, and the manner for analyzing the plural items of observation information;
transmission knowledge determination procedure that receives said observation information analyzed in said system analysis procedure and a policy from a policy storage means that stores policies which are criteria for judging whether or not a monitored system is secure, and determines whether or not transmission of transmission information in place of respective items of observation information will have an influence on the determination of a policy, based on the information stored in a transmission knowledge storing means that stores combinations of the transmission information and the plural items of observation information that are information to be transmitted instead of transmitting all the items of the observation information analyzed in said system analysis procedure, wherein the transmission information is defined as information representative of relevant observation information; and
information transmission procedure that transmits the observation information, and the transmission information for which a determination has been made not to have an influence on the determination of a policy by said transmission knowledge determination procedure.

14. The computer program product according to claim 13, further comprising:
transmission knowledge conversion procedure that converts the policy comprised of the plural items of the observation information alone into the policy comprised of the transmission information and the plural items of observation information that have been transmitted by said information transmission procedure so that the determination of a policy may be possible based on the plural items of observation information and the transmission information that have been transmitted by said information transmission procedure; and
policy determination procedure that determines whether or not the transmission information and the plural items of observation information satisfy the policy.

15. The computer program product according to claim 13, further comprising transmission knowledge generation procedure that retrieves a policy from said policy storage means, defines a new state by combining plural items of observation information from among the plural items of observation information that constitute said policy, extracts a combination of the plural items of observation information that does not have an influence on the determination of a policy or does not increase the number of states even when the transmission information is utilized in place of the plural items of observation information, and stores the correspondence between the transmission information and the plural items of observation information in said transmission knowledge storage means as transmission knowledge.
